(19) United States
(12) Patent Application Publication
(10) Pub. No.: US 2012/0216584 A1
(43) Pub. Date: Aug. 30, 2012

(54) ROTARY-STYLE COMBINATION LOCK ASSEMBLIES AND ASSOCIATED METHODS

(75) Inventors: Kurt Kemppainen, Mound, MN (US); Peter Schmidt, San Jose, CA (US)

(73) Assignee: Wordlock, Inc., Santa Clara, CA (US)

(21) Appl. No.: 13/218,368

(22) Filed: Aug. 25, 2011

Related U.S. Application Data
(60) Provisional application No. 61/377,071, filed on Aug. 25, 2010.

(51) Int. Cl. E05B 37/04; B23P 11/00

(52) U.S. Cl. 70/305; 29/407.1

(57) ABSTRACT

The present disclosure describes rotary-style combination locks and associated methods of manufacture and use. In one embodiment, a lock includes a locking member movable between locked and unlocked configurations with respect to a housing and a dial having characters around the circumference that align with an indicator to enter the lock's combination. The lock can include combination discs having tabs oriented thereon that allow the lock to have a predefined combination including adjacent characters on the dial.

### CROSS REFERENCE TO RELATED APPLICATION

This application is related to and claims priority to U.S. Provisional Patent Application No. 61/377,071, titled Rotary-Style Combination Lock Assemblies And Associated Methods, filed Aug. 25, 2010, which is incorporated herein in its entirety by reference thereto.

### TECHNICAL FIELD

The present technology relates to lock devices and locking methods. In particular, the present invention relates to a rotary-style combination lock assembly and associated locking methods.

### BACKGROUND

Locks are commonly used for securing a wide variety of objects. For instance, locks are frequently used to secure lockers, toolboxes, luggage, gates, containers, bicycles and the like. One main disadvantage of a key-based lock is that a physical key is required to open the lock. A key to a lock may often be misplaced, may be inconvenient to carry, and may be difficult to remember.

Combination locks overcome many of the disadvantages of key-based locks by providing a numeric combination instead of a physical key to open the lock. Conventional rotary-style combination locks have a rotating dial that displays a range of numbers. To enter a combination, a user can rotate the dial in opposing directions (e.g., right, left, right) and align each number of the combination with an indicator (e.g., an indent). Once the combination is entered, the lock moves to an unlocked configuration such that the lock's shackle can move between open and closed positions. Locking mechanisms (e.g., internal disc assemblies) of conventional rotary-style combination locks prevent lock combinations from including sequential numbers (e.g., 1, 2, 3) and require that combinations comprise either entirely even numbers or entirely odd numbers, thereby limiting the number of lock combinations. Due to the above mentioned disadvantages, it is desirable to provide a key-less rotary-style combination lock that can provide a greater range of combinations.

### SUMMARY

The present invention is directed to a rotary-style combination locks, lock systems and methods that overcome drawback experienced in the prior art and that provide other benefits. At least one embodiment provides a rotary-style combination lock unlockable upon inputting a multiple character preselected combination, wherein the combination is selected before assembling the combination lock. The lock comprises a housing, a locking member connected to the housing, and a dial rotatable relative to the housing. The dial has a plurality of alphabetical characters disposed thereon, and the preselected combination is made up of one or more of the alphabetical characters on the dial. The lock has a plurality of combination discs contained in the housing and coupled to the dial. Each combination disc has an unlocking feature. When the lock is manipulated to input the preselected combination, the combination discs are all in an unlocked arrangement with the unlocking features in alignment. Each combination disc has a combination feature positioned relative to the dial and the unlocking feature so each combination disc is associated with a respective one of the characters of the multi-character combination. The combination discs is selected to correspond to the characters of the preselected combination and the combination discs are arranged so that the characters associated with the combination discs are in a sequence that spells at least one of a word, abbreviation, and acronym corresponding to the combination.

In one embodiment the plurality of combination discs includes at least first and second combination discs. The first combination disc is associated with a first character on the dial, and the second combination disc is associated with a second character on the dial, wherein the second character is immediately adjacent to the first character on the dial.

In another embodiment the plurality of combination discs includes a first combination disc having a first combination feature selectively positioned relative to a first unlocking feature and relative to the dial so the first combination disc is associated with a first character on the dial that is a first character in the combination, and the plurality of combination discs includes a second combination disc having a second combination feature selectively positioned relative to a second unlocking feature and relative to the dial so the second combination disc is associated with a second character on the dial that is a second character in the combination, wherein the first and second characters on the dial are immediately adjacent to each other on the dial. In another embodiment, the first and second characters in the combination are the same character on the dial.

Another aspect of the invention provides a rotary-style combination lock unlockable upon inputting a multiple character preselected combination, wherein the combination is selected before assembling the combination lock. The lock has a housing, a locking member coupled to the housing, and a dial rotatably mounted relative to the housing. The dial has a plurality of characters disposed about a circumferential portion of the dial. The preselected combination is made up of one or more of the alphabetical characters that spell at least one of a word, an abbreviation, and an acronym. The lock has a stack of combination discs contained in the housing and coupled to the dial. Each combination disc has an unlocking feature. When the lock assembly is manipulated to input the multiple character combination, the unlocking features are in alignment in an unlocked position, and the unlocking features are in a locked position when the unlocking features are misaligned. Each combination disc has a combination feature positioned relative to the characters on the dial and relative to the unlocking feature so each combination disc is associated with a respective one of the characters of the preselected combination. The combination discs being selected and arranged so that the characters associated with the combination discs spell the at least one of a word, an abbreviation, and an acronym.

Another embodiment provides a rotary-style combination lock system for providing a combination lock unlockable upon inputting a multiple character preselected combination, wherein the combination is selected before assembling the combination lock. The lock system comprises a lock body and a rotatable dial having a plurality of alphabetical characters disposed thereon. The preselected combination is made up of one or more of the alphabetical characters. The lock system includes a plurality of combination discs sized to be rotatably disposed in the housing and coupled to the dial. Each combination disc has an unlocking feature and has a combination feature positioned on the disc relative to the unlocking feature so each combination disc is uniquely associated with a respective one of the characters on the dial. Each lock includes combination discs selected to correspond to the characters of the preselected combination. The combinations discs are rotatably arranged in the housing, connected to the dial, and arranged so that rotating the dial to input the characters corresponding to the preselected combination spells at least one of a word, abbreviation, and an acronym.

Another aspect of the invention provides a method of making a rotary-style combination lock assembly manipulatable to input a multiple character combination that allows the lock assembly to move from the locked position to the unlocked position. The lock assembly comprises a housing, a locking member, and a dial having a plurality of characters disposed about a circumferential portion of the dial, wherein selected characters can be combinable to form at least one of a word, an abbreviation, and an acronym. The lock assembly includes a first plurality of combination discs, and each disc is associated with a selected one of characters that define the multiple-character combination. The method comprises selecting the multiple character combination from a plurality of words, abbreviations or acronyms, and selecting the first plurality of combination discs from a second plurality of combination discs, wherein each of the combination discs of the second plurality of combinations are associate with selected ones of the characters on the dial. The first selected combination disc is constructed to correspond to a first character of the combination, the second selected combination disc is constructed to correspond to a second character of the combination, and the third selected combination disc is constructed to correspond to a third character of the combination. The method includes positioning the first, second and third selected combination discs in the housing and coupling the first, second and third selected combination discs to the dial in an arrangement in a arrangement whereby the associated the first, second and third characters of the combination are in a sequence that spells the selected word, abbreviation or acronym forming the combination. The method includes coupling the combination discs and the housing to the locking member.

### BRIEF DESCRIPTION OF THE DRAWINGS

FIG. 1 is an elevation view illustrating a locked configuration of a rotary-style combination lock in accordance with an embodiment of the present disclosure.

FIG. 2 is a partial exploded isometric view illustrating a housing and a disc assembly for a rotary-style combination lock with a first character of a combination entered and configured in accordance with an embodiment of the present disclosure.

FIG. 3 is a partial exploded isometric view illustrating the housing and the disc assembly of FIG. 2 with a second character of the combination entered.

FIG. 4 is a partial exploded isometric view illustrating the housing and the disc assembly of FIG. 3 with the combination entered.

FIGS. 5A-D are diagrams illustrating tab orientation on a series of first combination discs in accordance with embodiments of the present disclosure.

FIG. 6 is a flow diagram illustrating a routine for predefining a combination for a rotary-style lock in accordance with embodiments of the present disclosure.

### DETAILED DESCRIPTION

The following describes embodiments of rotary-style combination locks and associated methods of manufacture and use in accordance with the present disclosure. In several embodiments of the present disclosure, a rotary-style combination lock can include a disc assembly having tabs spaced apart from one another such that a combination for the lock can include characters adjacent to one another on a dial (e.g., 1-2-3). A lock in accordance with the present disclosure can further include tabs arranged on a disc assembly corresponding to a predefined combination, thereby preventing locks from having nonsensical combinations with random characters (e.g., B-C-T). Embodiments of combination locks can include, but are not limited to padlocks, luggage locks, bike locks, and cable locks. Embodiments in accordance with the present disclosure are set forth hereinafter to provide a thorough understanding and enabling description of a number of particular embodiments. Numerous specific details of various embodiments are described below with reference to textual combination locks having alphabetical characters that comprise lock combinations, but embodiments can be used with other locks and with other indicia (e.g., symbols, etc.). In some instances, well-known structures or operations are not shown, or are not described in detail to avoid obscuring aspects of this invention. A person skilled in the art will understand, however, that the invention may have additional embodiments, or that the invention may be practiced without one or more of the specific details of the embodiments as shown and described.

Many of the details, dimensions, angles, and other features shown in the Figures are merely illustrative of particular embodiments of the disclosure. Accordingly, other embodiments can have other details, dimensions, angles, and features without departing from the spirit or scope of the present disclosure. In addition, those of ordinary skill in the art will appreciate that further embodiments of the disclosure can be practiced without several of the details described below.

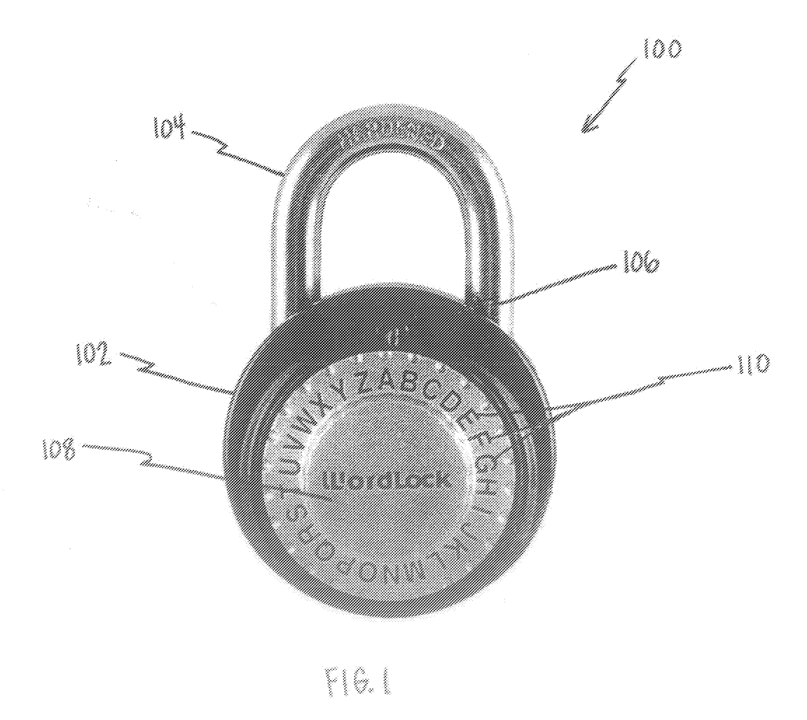

FIG. 1 shows a locked configuration of a rotary-style combination lock 100 (“lock 100”) in accordance with an embodiment of the present disclosure. In the illustrated embodiment, the lock 100 includes a housing 102, a locking member 104, an indicator 106, and a dial 108. The locking member 104 can be a shackle as shown FIG. 1, a hasp, and/or another suitable strong member. The housing 102 and the dial 108 can comprise a suitably strong material, such as metal. The locking member 104 is operatively coupled to the housing 102 such that the locking member 104 can move from the locked configuration shown in FIG. 1 to an unlocked configuration upon entry of a combination. In the locked configuration, a free end (not visible) of the locking member 104 can engage with the housing 102, thereby preventing a secured object (e.g., a locker door closure) from passing between the housing 102 and the free end. In the unlocked position, a user can displace and pivot the locking member 104 with respect to the housing 102 to release the object.

The lock 100 can further include a plurality of characters 110 of which a specific set of characters 110 can define the lock's combination. The characters 110 can be positioned around the circumference of the dial 108 such that the user can rotate the dial 108 with respect to the housing 102, and align individual characters 110 with the indicator 106 (e.g., a notch, protrusion, arrowhead, line, etc.) to enter the lock's combination. For example, if the lock 100 has a three character combination, the user can rotate the dial 108 multiple times in a clockwise direction until a first character 110 of the combination aligns with the indicator 106, then rotate the dial 106 twice in a counterclockwise direction until a second character 110 of the combination aligns with the indicator 106, and in a clockwise direction until a third character 110 of the combination aligns with the indicator 106. Once the final character of the combination is entered, the lock 100 can move to the unlocked configuration, releasing the free end of the locking member 104. In further embodiments, the lock 100 can have a combination comprising more or less characters 110 and/or the lock 100 can include more or less characters 110 on the dial 108.

The characters 110 shown in FIG. 1 include alphabetical characters (i.e., A-Z), such that the lock 100 has a textual combination that is easier for the user to remember than conventional number combinations. For example, the lock 100 can have a three letter combination that spells meaningful three letter words (e.g., B-A-T, D-O-G, Z-A-G), abbreviations (e.g., M-R-S, E-T-C), and/or three-letter acronyms (“TLAs”) (e.g., L-O-L, B-R-B, F-Y-I). In further embodiments, the characters 110 can include other suitable indicia, such as symbols and/or pictures.

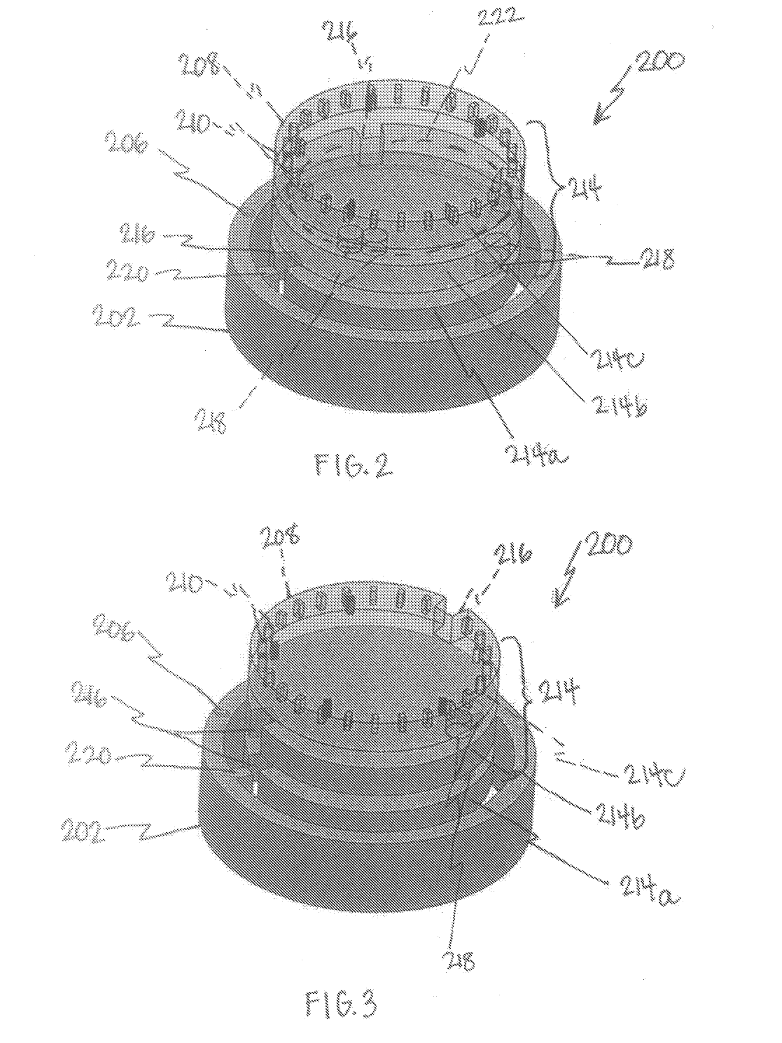

The lock 100 can have a predefined combination selected before the lock is assembled. In one embodiment, a list of desired 3-letter combinations that include words, abbreviations, and/or TLAs can be created or complied. The locks are then manufactured so that the combination for each lock is one of the predetermined 3-letter combinations. Accordingly, the combinations for the locks are all preselected before manufacturing, rather than randomly generated during the manufacturing process. For example, a manufacturer can select a desired combination for the lock 100, and can build a disc assembly (described in detail in FIGS. 2-4) corresponding to the selected combination. Predefining combinations can prevent textual locks (e.g., the lock 100 including alphabetical characters 110) from having random letter combinations and can ensure that each lock combination is a meaningful word, TLA, and/or abbreviation (e.g., B-A-T, L-O-L, M-R-S, etc.).

Predefining combinations also allows the combination of the lock 100 to include immediately adjacent characters 110. For example, locks manufactured in accordance with the present disclosure can have combinations such as B-A-N, C-A-B, D-O-N, etc. The lock 100 of at least one embodiment can be manufactured so that the same letter can be used more than once in a combination. For example, the lock 100 can be constructed by selecting discs so that the 3-letter combination uses same letter two or more times (e.g., B-R-B, or L-O-L), including the same letter immediately adjacent to each other in the combination (e.g., B-F-F, or A-A-A). Allowing locks to have combinations that include immediately adjacent characters 110 or even the same character used more than once increases the number of possible combinations, thereby making it more difficult for an unauthorized user to guess a combination. Additionally, allowing textual combination locks (e.g., the combination for the lock 100) to include adjacent letters expands the number of meaningful words, abbreviations, or TLAs that can be used as combinations. In further embodiments, the lock 100 does not have a predefined combination, but the subsequently determined combination can include adjacent characters 110.

FIGS. 2-4 are partial exploded views of a housing 202 and a disc assembly 214 for a rotary-style combination lock 200 (“the lock 200”) shown in successive stages of entering a combination. In the embodiment illustrated in FIGS. 2-4, the lock 200 can include several features generally similar to the lock 100 described above, such as the housing 202, a locking member (not shown), an indicator 206, a dial 208, and a plurality of characters 210 around the circumference of the dial 208. A particular set of the characters 210 comprise the lock's combination. FIGS. 2-4 further show the lock 200 can include an unlocking lever 220 that is operatively coupled to the disc assembly 214 and the locking member. Similar to a conventional rotary-style combination lock, the unlocking lever 220 can move the lock 200 from a locked configuration and an unlocked configuration when a user enters the combination.

Referring to FIGS. 2-4 collectively, the disc assembly 214 can include a first combination disc 214a, a second combination disc 214b, and a third combination disc 214c, each disc 214 corresponding to a character of the combination. The discs 214 can operatively couple to a spindle (not shown) that runs through each disc 214 and drives the third combination disc 214c. The discs 214 can comprise suitable disc materials known in the art, such as metal and plastic.

Each disc 214 includes a notch 216 and at least one tab 218 (e.g., a protrusion, nib, etc.). The tabs 218 are arranged tangentially on each disc 214 along a theoretical bolt circle 222, such that each tab 218 can contact a tab 218 on the adjacent disc 214. For example, as shown in FIG. 2, the first combination disc 214a includes one tab 218 that can contact the tab 218 on the adjacent second combination disc 214b, and the second combination disc 214c includes another tab 218 on its opposing side that can contact the tab 218 on the adjacent third combination disc 214c. In one embodiment in accordance with the present disclosure, the discs 214 can have a 0.75 inch diameter, the bolt circle 222 can have a 0.625 inch diameter, and the tabs 218 can have a 0.076 inch diameter. In this configuration, the lock 200 can include twenty-six tabs 218 arranged tangentially along the bolt circle 222 corresponding to the letters “A” through “Z”. In further embodiments, the discs 214, the bolt circle 222, and the tabs 218 can have different diameters to accommodate more or less characters 210. The placement of the tabs 218 along the bolt circle 222 can correspond to a specific character 210 such that the lock 200 can have a predetermined combination. Additionally, the tabs 218 can be placed along the bolt circle 222 such that the lock's combination can include adjacent characters 210.

In operation, the user can enter the lock's combination with the dial 208 to move the lock 200 from the locked configuration to the unlocked configuration. In FIG. 2, the user has entered a first character of the, combination by rotating the dial 208 in a first direction. The rotation of the dial 208 causes the spindle to spin the third combination disc 214c such that the tab 218 on the third combination disc 214c contacts the tab 218 on the adjacent second combination disc 218b. As the dial 208 continues to rotate, the tabs 218 on adjacent discs 214 continue to contact until all the combination discs 214a-c are spinning. The user can stop the rotation when the first character of the combination aligns with the indicator 206, thereby aligning the notch 216 on the first combination disc 214a with the unlocking lever 220.

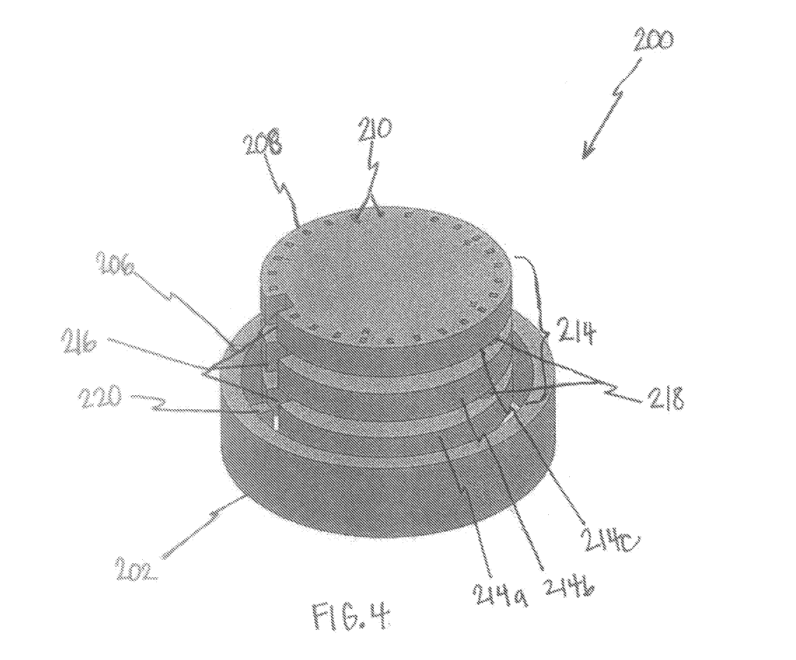

In FIG. 3, the user has entered a second character of the combination. To enter the second character, the user can rotate the dial 208 in a second direction opposite the first direction, and continue to rotate the dial 208 until the second and third combination discs 214b-c are spinning. The user can stop rotation when the second character of the combination aligns with the indicator 206, thereby aligning the notch 216 on the second combination disc 214b with the unlocking lever 220.

In FIG. 4, the user has entered the third character of the combination by rotating the dial 208 in the first direction to spin the third combination disc 214c. When the third character of the combination aligns with the indicator 206, the notch 216 on the third combination disc 214c aligns with the unlocking lever 220. The aligned notches 216 allow the unlocking lever 220 to drop, thereby moving the lock 200 from the locked configuration to the unlocked configuration. In the embodiment illustrated in FIGS. 2-4, the lock 200 includes three discs 214 corresponding to a three character combination. In further embodiments, locks can have fewer or greater discs 214 corresponding to shorter or longer combinations. As also illustrated in FIGS. 2-4, the third combination disc 214c and the dial 208 can be integrally formed to reduce production time and/or costs. In further embodiments, the dial 208 and the third combination disc 214c may be distinct features. In still further embodiments, the spindle can drive a cam member behind the first combination disc 214a such that the notches 216 of the discs 214 align with the unlocking lever 220 in reverse order (e.g., the notch 216 on the third combination disc 214c corresponds to the first character of the combination).

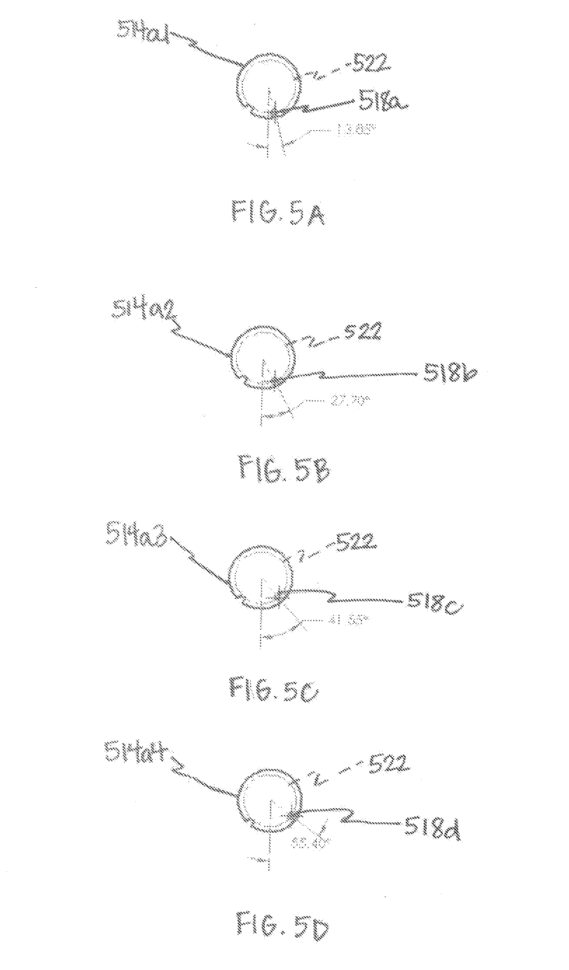

FIGS. 5A-D are diagrams illustrating tab orientation on first combination discs of at least one embodiment, such as the tab 218 on the first combination disc 214a described in FIGS. 2-4. FIG. 5A shows a first combination disc 514a1 having a tab 518a positioned along a bolt circle 522 at a tab angle of 13.85°. The tab 518a can correspond to a first character on a dial (e.g., a character 110 on the dial 108 in FIG. 1). FIG. 5B shows that another first combination disc 514a2 can have a tab 518b positioned along the bolt circle 522 at tab angle of 27.7°. The tab 518b corresponds to a second character on the dial that is adjacent to the first character in FIG. 5A. FIGS. 5C and 5D show tabs 518c and 518d spaced along the bolt circle 522 at tab angles incrementally increasing by 13.85°, such that each tab 518c and 518d corresponds to an adjacent character on the dial.

Arranging tabs 518 incrementally along the bolt circle 522 at a tab angles increasing by 13.85° allows rotary-style combination locks, such as the locks 100 and 200 described in FIGS. 1 and 2, to have combinations beginning with each character on the dial. The tab angles shown in FIGS. 5A-C are reduced from conventional tab angels. The reduced tab angles increase the number of different discs that can be used as the first combination disc 514a in a disc assembly (e.g., the disc assembly 214 in FIGS. 2-4). Other discs in a disc assembly of a rotary-style combination lock (e.g., second and third combination discs) can position tabs using the same reduced tab angles described above, thereby allowing locks to have combinations including adjacent characters and increasing the number of possible lock combinations. In further embodiments, the tab angle ensuring the use of each character on a dial in a combination can increase or decrease depending upon the diameters of the tabs, the diameters of the combination discs, and/or the number of characters on the dial.

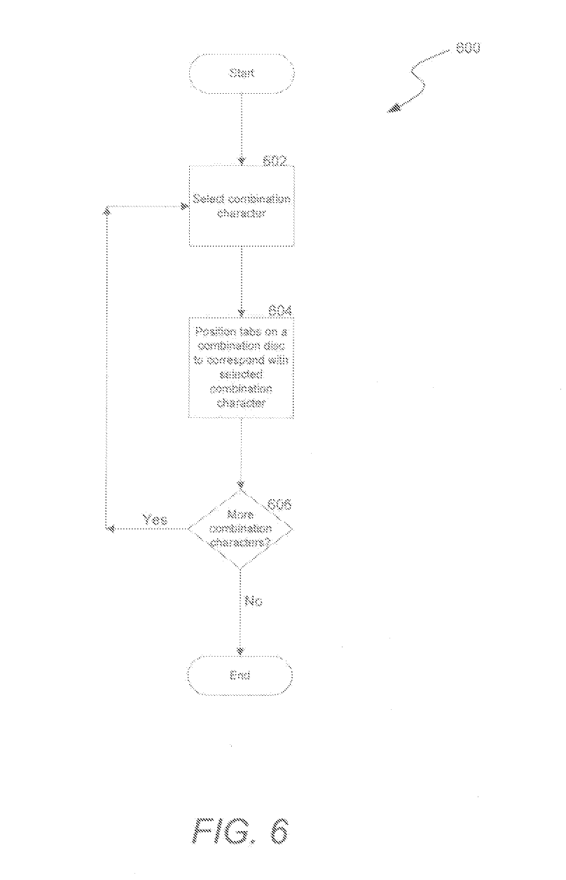

FIG. 6 is a flow diagram illustrating a routine 600 for predefining a combination for a rotary-style combination lock in accordance with embodiments of the present disclosure. In block 602, a manufacturer can select a character on a dial (e.g., the characters 110 on the dial 108 in FIG. 1) for a lock combination. In block 604, the manufacturer can position a tab along a bolt circle of a combination disc (e.g., the tabs 218 on the discs 214 of FIG. 2) corresponding to the selected character. As described in FIG. 5, the combination disc can include a tab oriented at a tab angle corresponding to any character on a dial. Additionally, the combination disc can include tabs on opposing sides if the disc must contact discs on either side (e.g., the second combination disc 214b). If the combination includes more characters, the decision block 606 moves the routine 600 to blocks 602 and 604. The routine 600 continues to repeat blocks 602 and 604 until the predefined combination is complete and the tabs are oriented on the combination discs accordingly. The routine 600 can arrange the tabs on adjacent combination discs such that the tabs correspond to adjacent characters on the dial (e.g., A-B-C, etc.).

From the foregoing, it will be appreciated that specific embodiments of the present disclosure have been described herein for purposes of illustration, but that various modifications may be made without deviating from the present disclosure. For example, the rotary-style combination locks described above have textual combinations that can include adjacent letters (e.g., B-A-T). However, other embodiments of the disclosure can have combinations including adjacent symbols and/or combinations including other suitable indicia. Certain aspects of the present disclosure described in the context of particular embodiments may be combined or eliminated in other embodiments. For example, although embodiments of rotary-style combination locks described above have predefined combinations, other embodiments in accordance with the disclosure can include combinations that are determined after the lock is assembled. Further, while advantages associated with certain embodiments of the new technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A rotary-style combination lock unlockable upon inputting a multiple character preselected combination, wherein the combination is selected before assembling the combination lock, the lock comprising;
a housing;
a locking member connected to the housing;
a dial rotatable relative to the housing, the dial having a plurality of alphabetical characters disposed thereon, the preselected combination being made up of one or more of the alphabetical characters;
a plurality of combination discs contained in the housing and coupled to the dial, each combination disc having an unlocking feature, wherein when the lock is manipulated to input the preselected combination, the combination discs are all in an unlocked arrangement with the unlocking features in alignment, each combination disc having a combination feature positioned relative to the dial and the unlocking feature so each combination disc is associated with a respective one of the characters of the multi-character combination, the combination discs being selected to correspond to the characters of the preselected combination and the combination discs being arranged so that the characters associated with the combination discs are in a sequence that spells at least one of a word, abbreviation, and acronym corresponding to the combination.

2. The combination lock of claim 1 wherein the plurality of combination discs includes at least first and second combination discs, and the first combination disc is associated with a first character on the dial, and the second combination disc is associated with a second character on the dial, wherein the second character is immediately adjacent to the first character on the dial.

3. The combination lock of claim 1 wherein the plurality of combinations discs includes at least first and second combination discs, and the first and second combination discs are associated with the same character on the dial, whereby the combination includes at least two occurrences of the same character.

4. The combination lock of claim 1 wherein the plurality of combinations discs includes at least three combination discs and the combination is at least a three-character word, abbreviation, or acronym.

5. The combination lock of claim 1 wherein the plurality of combination discs includes a first combination disc having a first combination feature selectively positioned relative to a first unlocking feature and relative to the dial so the first combination disc is associated with a first character on the dial that is a first character in the combination, and the plurality of combination discs includes a second combination disc having a second combination feature selectively positioned relative to a second unlocking feature and relative to the dial so the second combination disc is associated with a second character on the dial that is a second character in the combination, wherein the first and second characters on the dial are immediately adjacent to each other on the dial.

6. The combination lock of claim 1 wherein the plurality of combination discs includes a first combination disc having a first combination feature selectively positioned relative to a first unlocking feature and relative to the dial so the first combination disc is associated with a first character on the dial that is a first character in the combination, and the plurality of combination discs includes a second combination disc having a second combination feature selectively positioned relative to a second unlocking feature and relative to the dial so the second combination disc is associated with a first character on the dial that is a second character in the combination, wherein the first and second characters in the combination are the same character on the dial.

7. The combination lock of claim 1, wherein the characters on the dial are the alphabetical characters of a selected alphabet and the alphabetical characters are arranged in alphabetical order around the dial.

8. The combination lock of claim 1 wherein the combination discs are coaxially aligned and rotatable about a common axis of rotation, the combination feature on each combination disc is spaced a same radial distance away from the axis of rotation, whereby at least one full revolution of a first combination disc will cause the combination feature on the first combination disc to engage the combination feature on a second combination disc axially adjacent to the first combination disc.

9. The combination lock of claim 1 wherein the unlocking features are notches.

10. The combination lock of claim 1 wherein the combination features are projections spaced radially inward of the unlocking features, each projection is positioned at a selected tab angle relative to the unlocking features on the respective combination disc.

11. The combination lock of claim 1 where the combination feature on each combination disc is positioned at a selected tab angle relative to the unlocking feature, and the tab angles are selected as a function of the number of characters on the dial.

12. The combination lock of claim 11 wherein the tab angle and the characters on the dial are positioned to allow the combination to include sequential characters in the combination immediately adjacent to each other on the dial.

13. The combination lock of claim 1 where the dial includes 26 characters disposed therearound, the combination feature on each combination disc is positioned at a selected tab angle relative to the unlocking feature, and the tab angles are selected as a multiple of approximately 13.85 degrees.

14. The combination lock of claim 1 where the combination feature on each combination disc is positioned at a selected tab angle relative to the unlocking feature, and the tab angles are selected as a function of the number of characters on the dial.

15. The combination lock of claim 1 wherein the plurality of combination discs includes at least four combination discs and the combination is at least one of a four-character word, abbreviation and acronym.

16. A rotary-style combination lock unlockable upon inputting a multiple character preselected combination, wherein the combination is selected before assembling the combination lock, the lock comprising;
a housing;
a locking member coupled to the housing;
a dial rotatably mounted relative to the housing and comprising a plurality of characters disposed about a circumferential portion of the dial, the preselected combination being made up of one or more of the alphabetical characters that spell at least one of a word, an abbreviation, and an acronym;
a stack of combination discs contained in the housing and coupled to the dial, each combination discs having an unlocking feature, wherein when the lock is manipulated to input the multiple character combination, the unlocking features are in alignment in an unlocked position, the unlocking features being in a locked position when the unlocking features are misaligned, each combination disc having a combination feature positioned relative to the characters on the dial and relative to the unlocking feature so each combination disc is associated with a respective one of the characters of the preselected combination, the combination discs being selected and arranged so that the characters associated with the combination discs spell the at least one of a word, an abbreviation, and an acronym.

17. The lock of claim 16 wherein the stack of combination discs includes at least first and second combination discs, and the first combination disc is associated with a non-numerical first character on the dial, and the second combination disc is associated with a non-numerical second character on the dial, wherein the second character is immediately adjacent to the first character on the dial.

18. The lock of claim 16 wherein the stack of combination discs includes at least first and second combination discs, and the first and second combination discs are associated with the same character on the dial, whereby the combination includes at least two occurrences of the same character.

19. The lock of claim 16 wherein the stack of combination discs includes three discs and the preselected combination is a three character word, abbreviation, or acronym.

20. The lock of claim 16 wherein the stack of combination discs includes a first combination disc having a first combination feature selectively positioned relative to a first unlocking feature and relative to the dial so the first combination disc is associated with a first character on the dial that is a first character in the combination, and the plurality of combination discs includes a second combination disc having a second combination feature selectively positioned relative to a second unlocking feature and relative to the dial so the second combination disc is associated with a second character on the dial that is a second character in the combination, wherein the first and second characters on the dial are immediately adjacent to each other on the dial.

21. The lock of claim 16 wherein the stack of combination discs includes a first combination disc having a first combination feature selectively positioned relative to a first unlocking feature and relative to the dial so the first combination disc is associated with a first character on the dial that is a first character in the combination, and the plurality of combination discs includes a second combination disc having a second combination feature selectively positioned relative to a second unlocking feature and relative to the dial so the second combination disc is associated with a first character on the dial that is a second character in the combination, wherein the first and second characters in the combination are the same character on the dial.

22. The lock of claim 16 wherein the combination discs are coaxially aligned and rotatable about a common axis of rotation, the combination feature on each combination disc is spaced a same radial distance away from the axis of rotation, whereby at least one full revolution of a first combination disc will cause the combination feature on the first combination disc to engage the combination feature on a second combination disc axially adjacent to the first combination disc.

23. The lock of claim 22 wherein the combination features are projecting tabs, each tabs being positioned at a selected tab angle relative to the unlocking feature, and the tab angles are selected as a function of the number of characters on the dial.

24. The lock of claim 16 wherein the combination feature on each combination disc is positioned at a selected feature angle relative to the unlocking feature, and the feature angles are selected as a multiple of approximately 13.85 degrees.

25. The lock of claim 16 wherein the combination feature on each combination disc is positioned at a selected feature angle relative to the unlocking feature, and the feature angles are selected as a function of the number of characters on the dial.

26. A rotary-style combination lock system for providing a combination lock unlockable upon inputting a multiple character preselected combination, wherein the combination is selected before assembling the combination lock, the lock system comprising:
a lock body;
a dial rotatable relative to the housing, the dial having a plurality of alphabetical characters disposed thereon, the preselected combination being made up of one or more of the alphabetical characters; and
a plurality of combination discs sized to be rotatably disposed in the housing and coupled to the dial, each combination disc having an unlocking feature and having a combination feature positioned on the disc relative to the unlocking feature so each combination disc is uniquely associated with a respective one of the characters on the dial;
wherein each lock includes the combination discs selected to correspond to the characters of the preselected combination, and the combinations discs are rotatably arranged in the housing and connected to the dial and arranged so that rotating the dial to input the characters corresponding to the preselected combination spells at least one of a word, abbreviation, an acronym.

27. The lock system of claim 26 wherein the selected combination discs includes at least first and second combination discs, and the first combination disc is associated with a first character on the dial, and the second combination disc is associated with a second character on the dial, wherein the second character is immediately adjacent to the first character on the dial.

28. A method of making a rotary-style combination lock assembly manipulatable to input a multiple character combination that allows the lock assembly to move from the locked position to the unlocked position, the lock assembly comprising a housing, a locking member, a dial having a plurality of characters disposed about a circumferential portion of the dial, wherein selected characters can be combinable to form at least one of a word, an abbreviation, and an acronym, and a first plurality of combination discs, each disc being associated with a selected one of characters that define the multiple-character combination, the method comprising:
selecting the multiple character combination from a plurality of words, abbreviations or acronyms;
selecting the first plurality of combination discs from a second plurality of combination discs, wherein each of the combination discs of the second plurality of combinations are associate with selected ones of the characters on the dial, wherein a first selected combination disc is constructed to correspond to a first character of the combination, a second selected combination disc is constructed to correspond to a second character of the combination, and a third selected combination disc is constructed to correspond to a third character of the combination;
positioning the first, second and third selected combination discs in the housing;
coupling the first, second and third selected combination discs to the dial in an arrangement in a arrangement whereby the associated the first, second and third characters of the combination are in a sequence that spells the selected word, abbreviation or acronym forming the combination; and
coupling the combination discs and the housing to the locking member.
